(19) United States
(12) Patent Application Publication
(10) Pub. No.: US 2009/0150358 A1
(43) Pub. Date: Jun. 11, 2009

(54) SEARCH DEVICE, SEARCH METHOD AND PROGRAM

(76) Inventor: YUKIHIRO OYAMA, Tokyo (JP)

Correspondence Address: NEC CORPORATION OF AMERICA, 6535 N. STATE HWY 161, IRVING, TX, 75039, US

(21) Appl. No.: 12/329,891

(22) Filed: Dec. 8, 2008

(30) Foreign Application Priority Data
Dec. 6, 2007 (JP) 316053/2007

(51) Int. Cl. G06F 17/30

(52) U.S. Cl. 707/3; 707/E17.022

(57) ABSTRACT

Disclosed is a search device including an extraction unit to extract search information from information inputted from environment by using a data mining analysis, a storing unit to store the search information, a selection unit to select supplementary information from the search information stored in the storing unit based on a keyword inputted from a terminal and profile information, a first transmission unit to transmit the keyword and the supplementary information to a search engine, and a second transmission unit to transmit to the terminal a search result outputted from the search engine. The supplementary information supplements to the keyword, and the profile information manages updating the storing unit for each user.

This application is based upon and claims the benefit of priority from Japanese Patent Application No. 2007-316053, filed on Dec. 6, 2007, the disclosure of which is incorporated herein in its entirety by reference.

### TECHNICAL FIELD

The present invention relates to a device for searching for information, a search method and a program.

### BACKGROUND ART

In recent years, an information search engine used for searching information has been evolving rapidly. When a user inputs a keyword to a terminal or the like, an information search engine, to which the terminal or the like is connected, searches for information related to the keyword from information all over the world based on the keyword. Results of the search are displayed on a screen of the terminal or the like as a list.

Japanese Patent Application Laid-open Publication No. 2004-110340 discloses a method of filtering information searched for on World Wide Web (WWW) based on a keyword inputted by a user. Information inherent in the user, a terminal or a network is stored in a search engine in advance. The inherent information is used for filtering.

Despite the filtering, sometimes a large amount of items are reported as search results, in which needed information, related information and advertising information are mixed together. In such a case, in order to find the needed information, it is necessary to refine a scope of the search by further appending a search criterion such as a keyword or by changing search criterion so as to reduce the number of search results.

When an inappropriate keyword is employed for the search criterion, the number of the search results may sometimes exceed tens of thousands.

### SUMMARY

An exemplary object of the invention is to provide a search device, a search method and a program that can efficiently obtain information needed by a user taking account of individual background of the user, who searches for information from information provided by a large number of Web servers existing on the Internet.

A device according to an exemplary aspect of the invention includes an extraction unit to extract search information from information inputted from environment by using a data mining analysis, a storing unit to store the search information, a selection unit to select supplementary information from the search information stored in the storing unit based on a keyword inputted from a terminal and profile information, a first transmission unit to transmit the keyword and the supplementary information to a search engine; and a second transmission unit to transmit to the terminal a search result outputted from the search engine. The supplementary information supplements to the keyword, and the profile information manages updating the storing unit for each user.

A method according to an exemplary aspect of the invention includes extracting search information from information inputted from environment by using a data mining analysis, storing the extracted search information, selecting supplementary information from the search information based on a keyword inputted from a terminal and profile information, transmitting the keyword and the supplementary information to a search engine, and transmitting to the terminal a search result outputted from the search engine. The supplementary information supplements to the keyword, and the profile information manages updating the stored search information for each user.

A computer readable medium, according to an exemplary aspects of the invention, embodying a program, the program causing a search device, connected to a terminal and a search engine, to perform a search method, the search method extracting search information from information inputted from environment by using a data mining analysis, storing the extracted search information, selecting supplementary information from the search information based on a keyword inputted from the terminal and profile information, transmitting the keyword and the supplementary information to the search engine, and transmitting to the terminal a search result outputted from the search engine. The supplementary information supplements to the keyword, and the profile information manages updating the stored search information for each user.

### BRIEF DESCRIPTION OF THE DRAWINGS

Exemplary features and advantages of the present invention will become apparent from the following detailed description when taken with the accompanying drawings in which:

FIG. 1 is an exemplary block diagram showing a configuration of a search system according to a first exemplary embodiment;

FIG. 2 is an exemplary block diagram showing a configuration of a search server according to the first exemplary embodiment;

FIG. 3 is an exemplary block diagram showing a configuration of a search server according to a second exemplary embodiment;

FIG. 4 is an exemplary flowchart showing a processing of a data mining analysis and of an extraction of supplementary information, performed in an information extracting unit according to the second exemplary embodiment;

FIG. 5 is exemplary block diagrams each showing a configuration of an information extracting unit performing the data mining analysis and the extraction processing for the supplementary information according to the second exemplary embodiment;

FIG. 6 is an exemplary block diagram showing a configuration of the search server compiling a database from user's material information according to the second exemplary embodiment;

FIG. 7 is an exemplary block diagram showing a configuration of the search server compiling a database from web information or industry press information, in which the user is interested, according to the second exemplary embodiment;

FIG. 8 is an exemplary block diagram showing a configuration of the search server compiling a database from web information or press information issued by an advertiser company according to the second exemplary embodiment; and

FIG. 9 is an exemplary block diagram showing a configuration of the search system performing a search process according to the second exemplary embodiment.

### EXEMPLARY EMBODIMENT

Next, a detailed explanation will be given for exemplary embodiments with reference to the drawings.

### First Embodiment

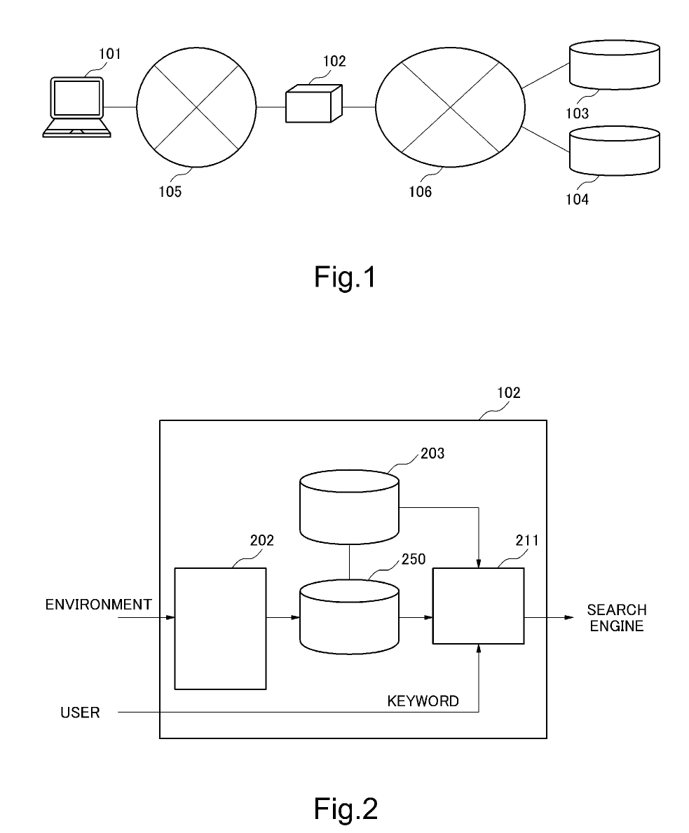

FIG. 1 is an exemplary block diagram showing a configuration of an information search system including an information search server according to the first exemplary embodiment.

As shown in FIG. 1, the information search system includes a user terminal 101, an information search server 102, an information search engine 103 and an information Web server 104. The user terminal 101 and the information search server 102 are connected via an intranet 105. The search server 102, the search engine 103 and the Web server 104 are connected via the Internet 106.

The user searches information, operating the user terminal 101 equipped with a communication function. The user terminal 101 includes an input means, such as a keyboard, a mouse or a touch panel, for inputting a search keyword. The user terminal 101 further includes a display means, which displays inputted information, information on a search result or the like. The search keyword inputted to the user terminal 101 is transmitted to the information search server 102 via the intranet 105.

The information search server 102 includes a database. The database stores individual information inherent in the user or information on a utilization environment in advance, as information supplementing the information search. The information search server 102 appends the supplementary information stored in the database to the search keyword transmitted from the user terminal 101 via the intranet 105, to generate a search criterion. The generated search criterion transmitted to the information search engine 103 via the Internet 106.

The information search engine 103 performs a search for information over the information Web server 104 based on the search criterion.

The information Web server 104 is a general term of web servers, which transmits various information on the Internet.

FIG. 2 illustrates an example of the information search server 102 according to a first exemplary embodiment shown in FIG. 1. The search server 102 includes an information extracting unit 202, a user profile database 203, a feature database 250, and a specific search condition selector 211 connected to the feature database 250 and receiving a search keyword from the user terminal 101. The information extracting unit 202 performs a data mining analysis, to extract supplementary information from information inputted from environment. The supplementary information is classified and stored in the feature database 250. The user profile database 203 stores a user profile, which manages updating the feature database 250 for each user. The specific search condition selector 211 selects the supplementary information related to the search keyword from the feature database 250 to be utilized supplementarily. The selected supplementary information is appended to the search keyword inputted by the user. The supplementary information is selected based on the search keyword and the profile, which is designated by the user. The keyword with the supplementary information is transmitted to the search engine.

### Second Embodiment

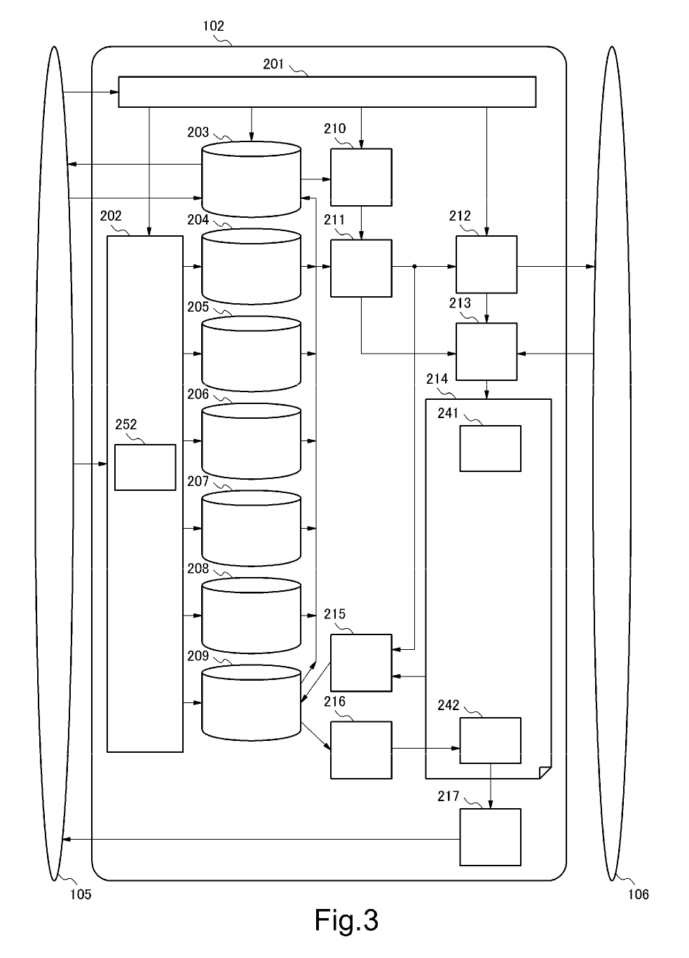

FIG. 3 illustrates an example of the information search server 102 according to a second exemplary embodiment shown in FIG. 1.

The search server 102 includes an information search control unit 201 receiving information from the user terminal 101 via the intranet 105, an information extracting unit 202 including a data mining engine 252, a user profile database 203 sending/receiving information to/from the user terminal 101, and various databases connected to the information extracting unit 202. The various databases include a material information database 204, a mail information database 205, a web utilization information database 206, a reputation information database 207, an industry trends database 208 and a company feature database 209. The information search server 102 further includes a user profile selector 210 connected to the user profile database 203, and a specific search condition selector 211 connected to the databases 203-209 and the user profile selector 210. An information collection search condition transmission unit 212 transmits output from the specific search condition selector 211 to the information search engine 103 via the Internet 106. Output from the specific search condition selector 211 is also transmitted to a listing advertisement posting unit 214 via a search result receiving/document editing unit 213. Information received from the information search engine 103 is also transmitted to the listing advertisement posting unit 214 via the search result receiving/document editing unit 213. An advertisement search condition synthesis/extraction unit 215 and a search result receiving/advertisement embedding unit 216 are connected to the company feature database 209. Also, by a portal screen edit information distribution unit 217, output from the listing advertisement posting unit 214 is transmitted to the user terminal 101 via the intranet 105. The listing advertisement posting unit 214 further includes an advertisement link listing unit 242.

The information search control unit 201 controls the whole of the information search server 102.

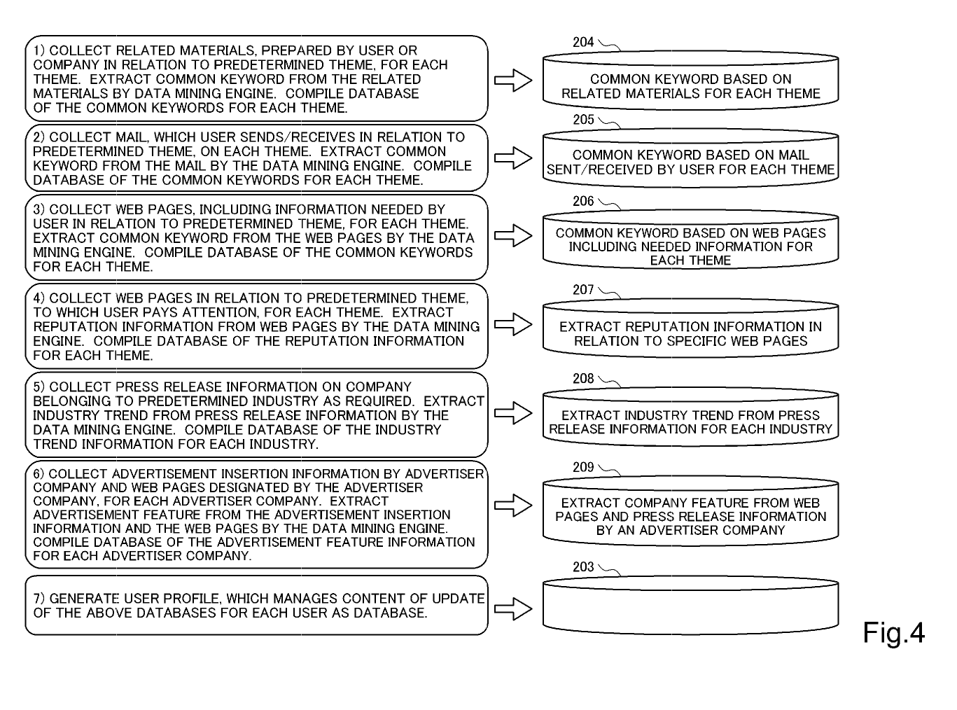

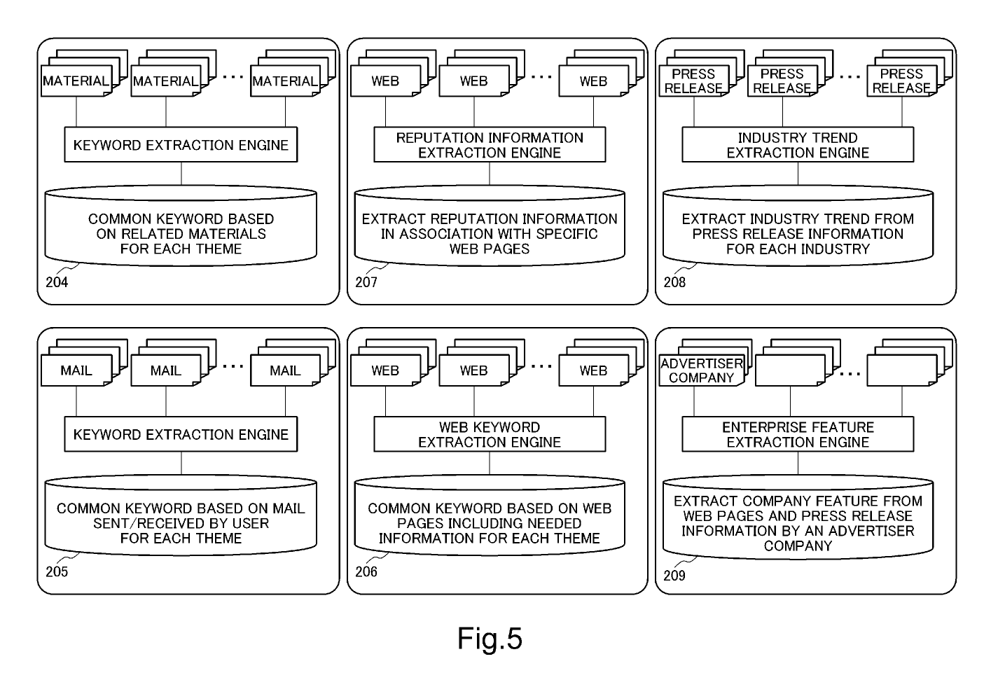

The information extracting unit 202 performs a data mining analysis, i.e. the information extracting unit 202 searches for an appearance pattern and a correlation between information elements from information transmitted from a terminal connected to the information search server 102, to extract supplementary information. The supplementary information includes, e.g. a common keyword or the like. The data mining engine 252 is used for the data mining analysis. The supplementary information extracted as above is stored in at least one of the material information database 204, the mail information database 205, the web utilization information database 206, the reputation information database 207, the industry trends database 208 and the company feature database 209. Processing in the information extracting unit 202 is described using FIGS. 4 and 5 in detail below.

Information stored in the material information database 204 is described as follows. Materials related to a predetermined theme prepared by an individual or a company are collected for each theme as environmental information. The data mining engine 252 in the information extracting unit 202 extracts a common keyword from the related materials. The extracted common keyword is search information. The common keyword is classified into each theme, and stored in the database. The predetermined theme is a category, set for classification in search, and is not limited to this embodiment.

Information stored in the mail information database 205 is described as follows. Information on an e-mail in relation to a predetermined theme, which the user sends/receives, is collected for each theme as environmental information. The data mining engine 252 in the information extracting unit 202 extracts a common keyword from the received e-mail information. The extracted common keyword is search information. The common keyword is classified into each theme, and stored in the database. The predetermined theme is a category, set for classification in search, and is not limited to this embodiment.

Information stored in the web utilization information database 206 is described as follows. Information on a web page including information required by the user in relation to a predetermined theme is collected for each theme as environmental information. The data mining engine 252 in the information extracting unit 202 extracts a common keyword from the information on the web page. The extracted common keyword is search information. The common keyword is classified into each theme, and stored in the database. The predetermined theme is a category, set for classification in search, and is not limited to this embodiment.

Information stored in the reputation information database 207 is described as follows. Information on a web page, to which the user pays attention in relation to a predetermined theme, is collected for each theme as environmental information. The data mining engine 252 in the information extracting unit 202 extracts reputation information from information on the web page. The reputation information is search information. The reputation information is classified into each theme, and stored in the database. The predetermined theme is a category, set for classification in search, and is not limited to this embodiment.

Information stored in the industry database 208 is described as follows. Press release information from a company belonging to a predetermined industry is collected as environmental information. The data mining engine 252 in the information extracting unit 202 extracts industry trends information from the press release information. The industry trends information is search information. The industry trends information is classified into each industry, and stored in the database.

Information stored in the company feature database 209 is described as follows. Advertisement insertion information of an advertiser company and information on a web page designated by the advertiser company are collected for each advertiser company as environmental information. The data mining engine 252 in the information extracting unit 202 extracts advertisement feature information from the advertisement insertion information and the information on the designated web page. The advertisement feature information is search information. The advertisement feature information is classified into each advertiser company, and stored in the database.

As described above, the environmental information collected for the data mining analysis is obtained via the intranet 105 or the Internet 106 from an external apparatus (not shown) connected to the information search server 102, and is transmitted to the information search server 102.

Hereinafter, the material information database 204, the mail information database 205, the web utilization information database 206, the reputation information database 207, the industry trends database 208 and the company feature database 209 are described as feature databases.

The user profile database 203 stores a user profile. The user profile manages updating the feature databases for each user.

The user profile selector 210 selects the supplementary information based on the search keyword and the profile designated by the user.

The specific search condition selector 211 selects the supplementary information related to the search keyword from the feature database to be utilized supplementarily.

The information collection search condition transmission unit 212 appends the selected supplementary information to the search keyword, to generate a search criterion. The generated search criterion is transmitted to the information search engine 103 via the Internet 106.

The search result receiving/document editing unit 213 receives a search result from the information search engine 103 or the information Web server 104. A document is prepared based on the received search result.

The advertisement search condition synthesis/extraction unit 215 selects information matched well with the search keyword and with the supplementary information from the company feature database 209.

The listing advertisement posting unit 214 displays the extracted matching information on the user terminal 101.

The search result receiving/advertisement embedding unit 216 embeds an advertisement article in the search result received by the search result receiving/document editing unit 213.

The portal screen edit information distribution unit 217 transmits a document, in which the search result and the advertisement article are embedded, to the user terminal 101 via the intranet 105.

The listing advertisement posting unit 214 includes a search result listing unit 241 and an advertisement link listing unit 242. The search result listing unit 241 displays as a list the search result received by the search result receiving/document editing unit 213. The advertisement link listing unit 242 displays as a list the advertisement embedded in the search result by the search result receiving/advertisement embedding unit 216.

A method to store the supplementary information in each feature database is described as follows.

FIGS. 4 and 5 show an example of the data mining analysis, and of extraction of the supplementary information in the information extracting unit 202.

The information extracting unit 202 performs the data mining analysis for information transmitted from a terminal connected to the information search server 102. As shown in FIGS. 4 and 5, the supplementary information extracted by the analysis is stored in each database.

The information extracting unit 202 performs the data mining analysis for related materials. The materials are data prepared by a user or by a company in relation to a predetermined theme. Such materials are collected for each theme. Through the data mining analysis, the data mining engine 252 extracts a common keyword. The common keyword is classified into each theme, and stored in the material information database 204.

The information extracting unit 202 also performs the data mining analysis for mail information. The mail information is information on an e-mail sent/received by a user in relation to a predetermined theme. Such mail information is collected for each theme. Through the data mining analysis, the data mining engine 252 extracts a common keyword. The common keyword is classified into each theme, and stored in the mail information database 205.

The information extracting unit 202 performs the data mining analysis for web page information. The web page information is information on a web page including information required by a user in relation to a predetermined theme. Such web page information is collected for each theme. By the data mining analysis, the data mining engine 252 extracts a common keyword. The common keyword is classified into each theme, and stored in the web utilization information database 206.

The information extracting unit 202 also performs the data mining analysis for web page information. The web page information is information on a web page, to which a user pays attention in relation to a predetermined theme. Such web page information is collected for each theme. By the data mining analysis, the data mining engine 252 extracts reputation information. The reputation information is classified into each theme, and stored in the reputation information database 207.

The information extracting unit 202 performs the data mining analysis for press release information from companies. The press release information from companies is information issued by the companies belonging to a predetermined industry. Such press release information from the companies is collected for each industry. By the data mining analysis, the data mining engine 252 extracts industry trend information. The industry trend information is classified into each industry, and stored in the industry database 208.

The information extracting unit 202 also performs the data mining analysis for advertisement insertion information and web page information. The advertisement insertion information is information on inserting advertisement by an advertiser company. The web page information is information on a web page designated by the advertiser company. The advertisement insertion information and the web page information are collected for each advertiser company. By the data mining analysis, the data mining engine 252 extracts advertisement feature information. The advertisement feature information is classified into each advertiser company, and stored in the company feature database 209.

A user profile, which manages updated content of the feature databases for each user, is compiled and stored in the user profile database 203.

An example of processing to compile each feature database is described as follows.

First, an example of compiling a database is described, wherein the data mining analysis is performed for information collected previously, and a result of the analysis is preliminarily registered, in order to efficiently collect information via the Internet 106.

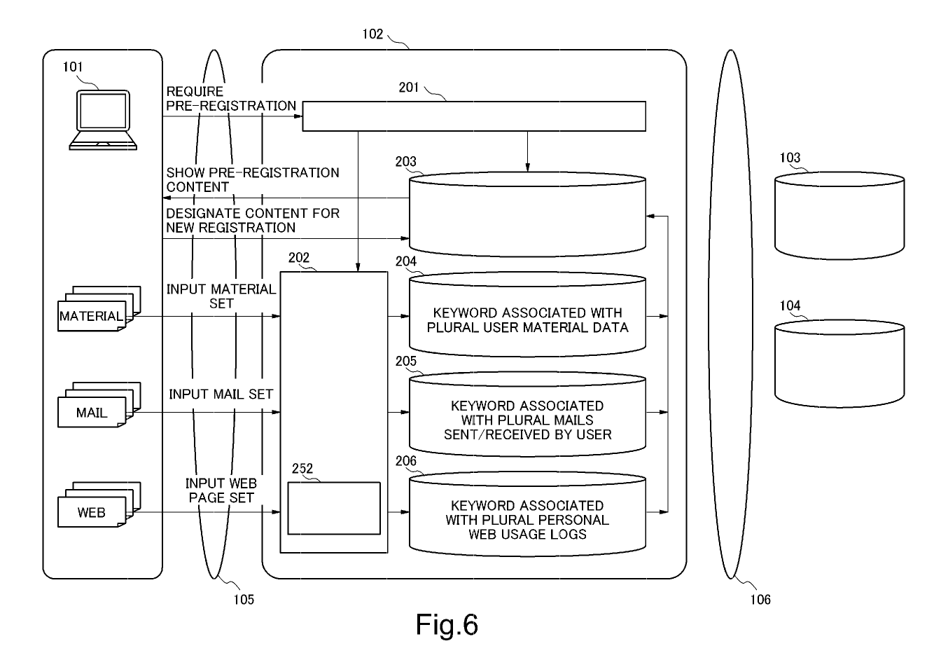

FIG. 6 illustrates an example of processing to compile a database from material information on a user.

The information search control unit 201 controls the whole information search server 102 and performs pre-registration.

The user requests pre-registration using the user terminal 101. The pre-registration request is transmitted to the information search server 102 from the user terminal 101 via the intranet 105. The transmitted registration request is received by the information search control unit 201 in the information search server 102.

The information search server 102 shows to the user the pre-registered content. The user designates a content to be newly pre-registered using the user terminal 101. For example, the content to be newly pre-registered includes “material set”, “mail set”, or “web article page set”, which will be described below. A keyword of interest in each set is designated. A content of the feature database updated by the above pre-registration processing is managed as a user profile.

A material set, in which materials accumulated or created previously are collected in relation to content of current interest, is prepared. A keyword for the current interest is also prepared. The material set and the keyword of interest are inputted to the information search server 102. By the data mining analysis based on the keyword of interest, the data mining engine 252 in the information extracting unit 202 extracts a feature keyword from the inputted material set for each item of the current interest.

Based on a group of the keywords obtained as above and the material set, the material information database 204 is created, wherein each of the keywords is associated with the plural material data on the user.

Updating the database is iterated by a number of the items of the current interest or by a number of combinations of the material sets.

A related mail set, in which sent/received mails are collected in relation to content of current interest, is prepared. The related mail set and the keyword of interest are inputted to the information search server 102. By the data mining analysis based on the keyword of interest, the data mining engine 252 in the information extracting unit 202 extracts a feature keyword from the inputted related mail set for each item of the current interest.

Based on a group of the keywords obtained as above and the related mail set, the mail information database 205 is created, wherein each of the keywords is associated with the plural mails sent/received by the user.

Updating the database is iterated by a number of the items of the current interest or by a number of combinations of the related mail sets.

A related web page set, in which web article pages used previously are collected in relation to content of the current interest, is prepared. The related web page set and the keyword of interest are inputted to the information search server 102. By the data mining analysis based on the keyword of interest, the data mining engine 252 in the information extracting unit 202 extracts a feature keyword from the inputted related web page set for each item of the current interest.

Based on a group of the keywords obtained as above and the related web page set, the web utilization information database 206 is created, wherein each of the keywords is associated with the plural related web page sets.

Updating the database is iterated by a number of the items of the content interest or by a number of combinations of related web article page sets.

Next, another example of compiling a database is described, wherein the data mining analysis is performed for information sources often used or for company information of interest, and a result of the analysis is preliminarily registered, in order to efficiently collect information via the Internet 106.

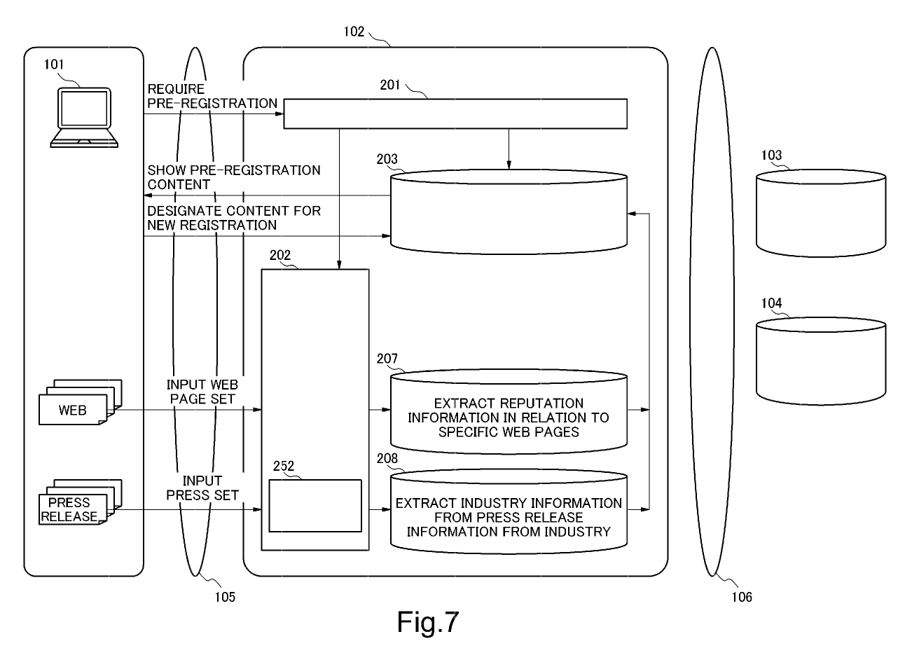

FIG. 7 shows an example of compiling a database from web article pages and industry press releases of interest.

The information search control unit 201 controls the whole information search server 102 and performs pre-registration.

The user requests pre-registration using the user terminal 101. The pre-registration request is transmitted to the information search server 102 from the user terminal 101 via the intranet 105. The transmitted registration request is received by the information search control unit 201 in the information search server 102.

The information search server 102 shows to the user pre-registered content. The user designates a content to be newly pre-registered using the user terminal 101, referring to pre-registered content. For example, the content to be newly pre-registered includes “specific web article page set” and/or “press release information page set”, which will be described below. A keyword of interest in each set is designated. A content of the feature database updated by the above pre-registration process is managed as a user profile.

A specific web page set, in which information on web article pages of interest is collected in relation to content of current interest, is prepared. A keyword for the current interest is also prepared. The specific web page set and a keyword of interest are inputted to the information search server 102. By the data mining analysis based on the keyword of interest, the data mining engine 252 in the information extracting unit 202 extracts a reputation keyword from the inputted specific web page set for each item of the current interest.

Based on a group of the keywords obtained as above, and the specific web article page set, the reputation information database 207 is created, wherein each of the reputation keywords is associated with the specific web article page set.

Updating the database is iterated by a number of the items of the current interest or by a number of combinations of the specific web article page sets.

An industry press release information page set, in which press release information pages of an industry of interest is collected in relation to content of current interest, is prepared. The industry press release information page set and the keyword of interest are inputted to the information search server 102. By the data mining analysis based on the keyword of interest, the data mining engine 252 in the information extracting unit 202 extracts an industry trend keyword from the industry press release information page set for each item of the current interest.

Based on a group of the keywords obtained as above and the industry press release information page set, the industry trend database 208 is created, wherein each of the keywords is associated with the plural industry press release information sets.

Updating the database is iterated by a number of the items of the current interest or by a number of combinations industry press release information page sets.

Next, another example of compiling a database is described as follows. In order to efficiently collect information via the Internet 106, the data mining analysis is performed for web information or press information transmitted from a contract company of listing advertisement, which applied for in advance, and a result of the analysis is preliminarily registered.

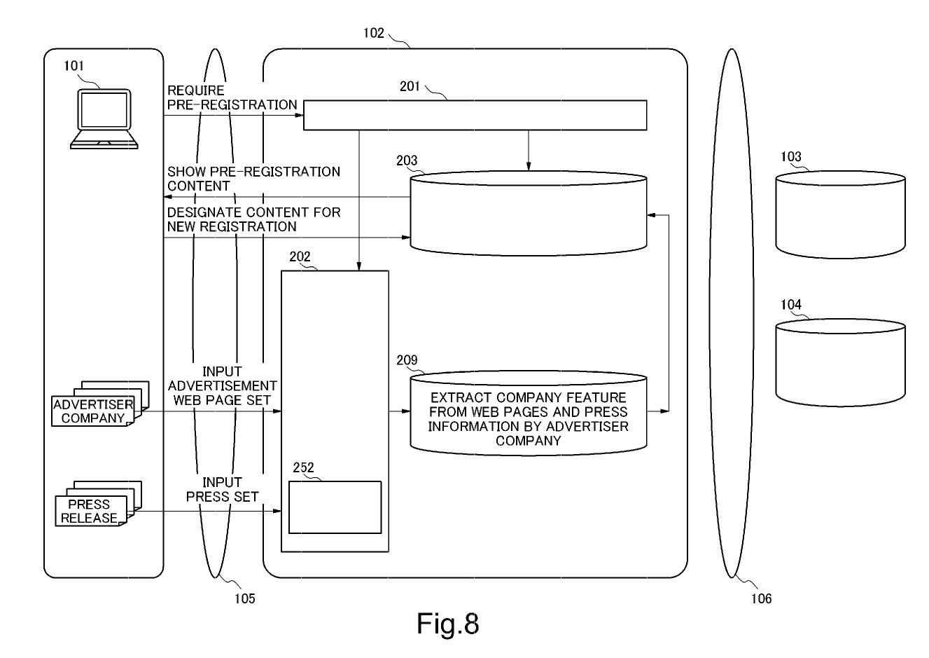

FIG. 8 shows an example of compiling a database from web information and press information of an advertiser company.

The information search control unit 201 controls the whole information search server 102 and performs pre-registration.

The user requests pre-registration using the user terminal 101. The pre-registration request is transmitted to the information search server 102 from the user terminal 101 via the intranet 105. The transmitted registration request is received by the information search control unit 201 in the information search server 102.

The information search server 102 shows to the user the pre-registered content. The user designates a content to be newly pre-registered using the user terminal 101, referring to content of the pre-registration. For example, the content to be newly pre-registered includes “company web article page set”, which will be described below. A technical field, a service related field or an academic research field in relation to the company web article page set is designated. A content of the feature databases updated by the above pre-registration process is managed as a user profile.

A data mining analysis is performed for web information or press information transmitted from the contract company of listing advertisement, which applied for in advance. In order to investigate technical fields, service related fields or a relevance to academic research fields, a company web article page set, in which the whole web article pages transmitted from contract companies are collected for each of the contract companies, is prepared. The company web article page set and an object field for investigation are inputted to the information search server 102. By a data mining analysis based on the investigation object field, the data mining engine 252 in the information extracting unit 202 extracts a feature keyword from the inputted company web article page set for each of the fields.

Based on a group of the keywords obtained as above and the company web article page set, the company feature database 209 is created, wherein each of the keywords is associated with company web article page set.

Updating the database is iterated by a number of the contract companies of listing advertisement or by a number of combinations of company web article page sets.

The databases prepared as above stores the supplementary information, which corresponds to a theme, an industry and an advertise company, in relation to the company web article page set.

A method of an information search using the compiled databases is described as follows.

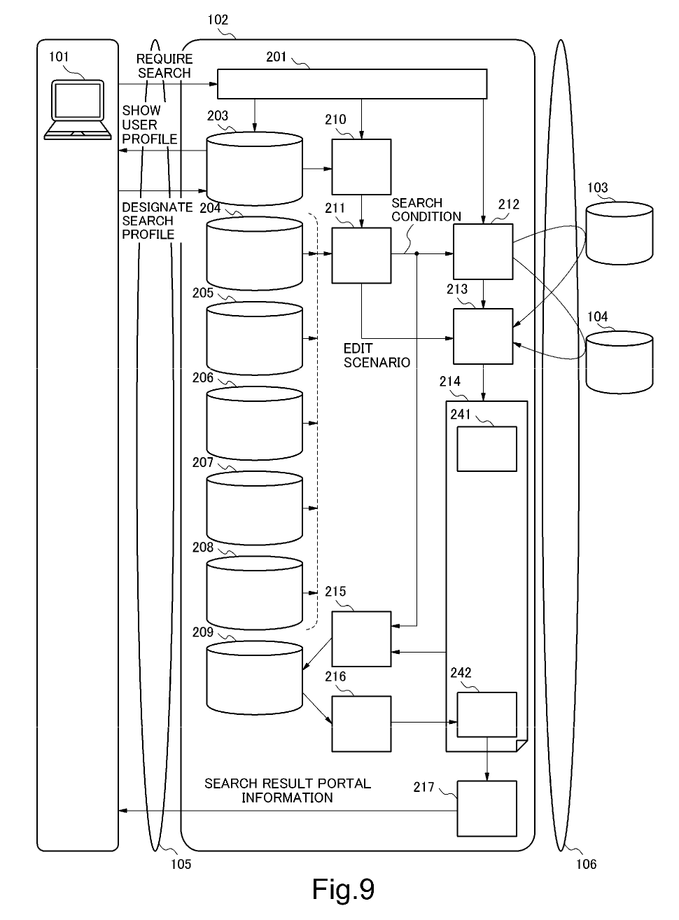

FIG. 9 shows an example of processing of an information search using the information search server 102 shown in FIG. 1.

The user inputs a search keyword to the user terminal 101. The inputted search keyword is transmitted, as a search request, to the information search server 102 from the user terminal 101 via the intranet 105. The transmitted search request is received by the information search control unit 201 in the information search server 102.

The information search server 102 shows to the user the user profile. The user designates a search profile to be inputted using the user terminal 101 referring to the user profile. The designated search profile is selected by the user profile selector 210 from the user profile database 203.

Supplementary information, which supplements the search keyword, is extracted by the specific search condition selector 211 from the feature database based on the selected search profile.

The search profile manages a user, i.e. the designated search profile allows extraction of the supplementary information according to the user from the feature database.

A common keyword and common information are stored in the feature database for each theme, and industry trend information is stored in the feature databases for each industry. Information stored in the feature databases is managed by the user profile database 203 for each user. By designating in a search profile who searches and which theme is searched, the supplementary information associated with the user and the theme is extracted.

When the supplementary information is selected by the specific search condition selector 211, a search condition, in which the supplementary information is appended to the search keyword inputted by the user, is outputted to the information collection search condition transmission unit 212. The information collection search condition transmission unit 212 generates a search criterion from the search keyword and the supplementary information. The generated search criterion is transmitted to the information search engine 103 via the Internet 106.

The information search engine 103 performs a search based on the search keyword and the supplementary information. The search result receiving/document editing unit 213 receives a result of the search. The supplementary information selected by the specific search condition selector 211 is sent to the search result receiving/document editing unit 213 as edit scenario information. The search result receiving/document editing unit 213 edits the search result, based on the edit scenario. The edited search result is sent to and stored in the listing advertisement posting unit 214.

The search condition outputted by the specific search condition selector 211 is also sent to the advertisement search condition synthesis/extraction unit 215. The advertisement search condition synthesis/extraction unit 215 extracts a company advertisement from the company feature database 209 based on the search condition and the search result stored in the listing advertisement posting unit 214. The extracted company advertisement is embedded in the search result, which is transmitted from the listing advertisement posting unit 214 via the advertisement search condition synthesis/extraction unit 215 and the company feature database 209, by the search result receiving/advertisement embedding unit 216.

The search result including the company advertisement is stored again in the listing advertisement posting unit 214. The search result is then read by the portal screen edit information distribution unit 217 from the listing advertisement posting unit 214, and is transmitted to the user terminal 101 via the intranet 105, as portal information on search result.

The user terminal 101 receives the search result transmitted from the portal screen edit information distribution unit 217, and displays the received search result on a screen.

As described above, information is provided on a result of a keyword search and on an advertisement link listing of an advertiser company closely associated with a condition of the keyword search, where the keyword search result and the advertisement link listing are combined with each other.

The following business model can be developed. When the advertisement link displayed on the user terminal 101 along with the search result is clicked, the user terminal 101 accesses the advertisement link listing unit 242. An advertisement associated with delivered information appears on the display, and an advertiser company pays an advertisement fee to the delivery server provider according to a number of accesses.

The processing of the information search server 102 may be performed by a dedicated logic circuit. Alternatively, a program describing the processing may be stored in a recording medium readable by the information search server 102, and then loaded on the information search server 102 for execution. The recording medium readable by the information search server 102 includes, for example, a HDD (hard disk drive) or the like, which is installed in the information search server 102 as well as a removable recording medium, such as a Floppy Disk™, a magneto-optical disk, a DVD or a CD. The program recorded in the recording medium is loaded on the information search control unit 201 in the information search server 102 and controlled by the information search control unit 201. Here, the information search control unit 201 operates as a computer which executes a program loaded from a recording medium.

As described above, the following advantages can be achieved according to the exemplary embodiment.

A feature is extracted beforehand through the data mining analysis for user's personal materials, collected web articles or companies of interest. The feature makes the information search efficient taking account of an individual background of the user performing keyword search.

Accuracy of the user's keyword search is improved. As a result, rapid collection of information becomes possible, and business efficiency increases.

Related advertisement article information is displayed as a list in addition to the information collected efficiently taking account of the individual background of the user. Because the advertisement article information suits user's preference, high advertising effect is expected.

In the related art, in order to find needed information, a search has to be iterated, appending a search condition such as a keyword. Furthermore, referring to a great deal of information, a scope of search has to be narrowed. Therefore, enormous time and effort are required to achieve the needed information finally.

When an improper search keyword is inputted, the needed information may be buried in the enormous items of the search result, and achieving the needed information becomes difficult.

Japanese Patent Application Laid-open Publication No. 2004-110340 discloses a two-step search having an algorithm for search on the web and an algorithm for filtering of the result, where these two algorithms differ from each other. The technology disclosed in JP-2004-110340 is different from a single step search, where a search result using plural keywords includes information reflecting a semantic relation between the keywords.

As described above, according to the exemplary embodiment, the data mining analysis is performed for environmental information provided from outside, and extracts feature information. The feature information extracted by the analysis is stored in advance for each predetermined category and managed along with the user's profile information. When the user searches information inputting to a search engine a search keyword transmitted from a user terminal, supplementary information to search keywords is selected from the feature information stored in advance, based on the search keyword and designated profile information. Then, a search criterion, based on the search keyword inputted by the user and on the selected supplementary information, is transmitted to the information search engine to perform a search. Therefore, an efficient search taking account of the individual background of the user who searches for information can be realized easily.

The previous description of the exemplary embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A search device comprising:
an extraction unit to extract search information from information inputted from environment by using a data mining analysis;
a storing unit to store said search information;
a selection unit to select supplementary information from said search information stored in said storing unit based on a keyword inputted from a terminal and profile information, said supplementary information supplementing to said keyword, and said profile information managing updating the storing unit for each user;
a first transmission unit to transmit said keyword and said supplementary information to a search engine; and
a second transmission unit to transmit to said terminal a search result outputted from said search engine.

2. The search device according to claim 1, wherein
a search criterion is generated from said keyword and said supplementary information, and is transmitted to said search engine.

3. The search device according to claim 1, wherein
said information inputted from environment is a material created by the user or a company.

4. The search device according to claim 1, wherein
said information inputted from environment is information on an e-mail sent or received by the user.

5. The search device according to claim 1, wherein
said information inputted from environment is information on a predetermined web page.

6. The search device according to claim 1, wherein
said information inputted from environment is press release information from a company classified into a predetermined category.

7. The search device according to claim 1, wherein
said information inputted from environment is advertising information by an advertiser.

8. The search device according to claim 7, wherein
said advertising information is advertisement insertion information of said advertiser or a web page designated by the advertiser.

9. The search device according to claim 1, further comprising;
an embedding unit to embeds an advertisement article in the search result transmitted from the search engine.

10. A search method comprising:
extracting search information from information inputted from environment by using a data mining analysis;
storing said extracted search information;
selecting supplementary information from said search information based on a keyword inputted from a terminal and profile information, said supplementary information supplementing to said keyword, and said profile information managing updating the stored search information for each user;
transmitting said keyword and said supplementary information to a search engine; and
transmitting to said terminal a search result outputted from said search engine.

11. The search method according to claim 10, wherein
a search criterion is generated from said keyword and said supplementary information, and is transmitted to said search engine.

12. The search method according to claim 10, wherein
said information inputted from environment is a material created by a user or a company.

13. The search method according to claim 10, wherein
said information inputted from environment is information on an e-mail transferred by a user.

14. The search method according to claim 10, wherein
said information inputted from environment is information on a predetermined web page.

15. The search method according to claim 10, wherein
said information inputted from environment is press release information by companies classified into a predetermined category.

16. The search method according to claim 10, wherein
said information inputted from environment is advertising information by an advertiser.

17. The search method according to claim 16, wherein
said advertising information is advertisement insertion information of said advertiser or a web page designated by advertiser.

18. The search method according to claim 10, further comprising;
embedding an advertisement article in the search result transmitted from the search engine.

19. A computer readable medium embodying a program, said program causing a search device, connected to a terminal and a search engine, to perform a search method, said search method comprising:
extracting search information from information inputted from environment by using a data mining analysis;
storing the extracted search information;
selecting supplementary information from said search information based on a keyword inputted from said terminal and profile information, said supplementary information supplementing to said keyword, and said profile information managing updating the stored search information for each user;
transmitting said keyword and said supplementary information to said search engine; and
transmitting to said terminal a search result outputted from said search engine.

20. A search device comprising:
extraction means for extracting search information from information inputted from environment by using a data mining analysis;
storing means for storing said search information;
selection means for selecting supplementary information from said search information stored in said storing means based on a keyword inputted from a terminal and profile information, said supplementary information supplementing to said keyword, and said profile information managing updating the storing means for each user;
first transmission means for transmitting said keyword and said supplementary information to a search engine; and
second transmission means for transmitting to said terminal a search result outputted from said search engine.
